(19) United States
(12) Patent Application Publication
(10) Pub. No.: US 2025/0053429 A1
(43) Pub. Date: Feb. 13, 2025

(54) Method for adaptive multi-window technology

(71) Applicant: MEDIATEK INC., Hsin-Chu (TW)

(72) Inventors: Chung-Yang Chen, Hsinchu City (TW); Cheng-Che Chen, Hsinchu City (TW); Chia-Chun Hsu, Hsinchu city (TW)

(73) Assignee: MEDIATEK INC., Hsin-Chu (TW)

(21) Appl. No.: 18/793,971

(22) Filed: Aug. 5, 2024

Related U.S. Application Data
(60) Provisional application No. 63/518,954, filed on Aug. 11, 2023.

(51) Int. Cl. G06F 9/451; G06F 9/50

(52) U.S. Cl. CPC G06F 9/452; G06F 9/5055

(57) ABSTRACT

A method for adaptive multi-window technology includes detecting a multi-window scenario corresponding to a plurality of windows on an electronic device, determining priorities of the plurality of windows, monitoring a plurality of performance indexes of the electronic device, checking whether resource re-allocation is needed according to the performance indexes, determining targets of the plurality of windows if resource re-allocation is needed, and changing profiles of the targets according to a resource re-allocation algorithm.

### CROSS REFERENCE TO RELATED APPLICATIONS

This application claims the benefit of U.S. Provisional Application No. 63/518, 954, filed on Aug. 11, 2023. The content of the application is incorporated herein by reference.

### BACKGROUND

A smartphone is a mobile device that combines the functionality of a traditional mobile phone with advanced computing capabilities. It typically has a touchscreen interface, allowing users to access a wide range of applications and services, such as web browsing, email, and social media, as well as multimedia playback and streaming. Smartphones also have built-in cameras, GPS navigation, and support for various communication methods, including voice calls, text messaging, and internet-based messaging apps.

Recently, with the improvement of smartphone platform performance and screen size, the usage for multi-window scenes by mobile users has increased. However, the hardware requirements (i.e., center processing unit (CPU)/graphic processing unit (GPU)/memory) for multi-window scenes are higher than those for single-window scenes. When the hardware resources cannot meet the scene requirements, users will have a poor experience (e.g., screen lagging, frame rate reduction).

### SUMMARY

A method for adaptive multi-window technology includes detecting a multi-window scenario corresponding to a plurality of windows on an electronic device, determining priorities of the plurality of windows, monitoring a plurality of performance indexes of the electronic device, checking whether resource re-allocation is needed according to the performance indexes, determining targets of the plurality of windows if resource re-allocation is needed, and changing profiles of the targets according to a resource re-allocation algorithm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an adaptive multi-window technology according to an embodiment of the present invention.

FIG. 2 is a flowchart of a method for adaptive multi-window technology in FIG. 1 according to an embodiment of the present invention.

### DETAILED DESCRIPTION

With stronger chipsets to handle computing workload demands at higher pixel rates, mobile video resolution and frame rate have caught up with dedicated consumer-grade cameras over years. The resolution of rear camera of smartphones can be 720p (HD), 1080p (Full HD), 2160p (4K), and 4320p (8K). The resolutions of displays in smartphones are shown as the following table:

TABLE 1
Resolutions of displays in smartphones

| row size | column size | standard |
|---|---|---|
| 720 | 1280 | standard high density (HD ready) display |
| 1080 | 1920 | standard Full HD (FHD) display |
| 1440 | 2560 | standard Quad HD (QHD) display |
| 2160 | 3840 | standard Ultra HD (UHD) display, 4K UHD |

In table 1, the row size is 720, 1080, 1440 or 2160 pixels, and the column size is 1280, 1920, 2560 or 3840 pixels. The resolutions of displays in smartphones are classified into high density (HD), full high density (FHD), quad high density (QHD), and ultra-high density (UHD). The present invention includes but is not limited to smartphones, and electronic devices with different display profiles can be applied in an embodiment of the present invention.

In recent times, as smartphone platforms have evolved, and screen sizes have expanded, the utilization of multi-window scenarios by mobile users has grown significantly. However, the hardware demands (such as the central processing unit (CPU), graphics processing unit (GPU), and memory) for multi-window environments surpass those needed for single-window setups. When the available hardware resources fall short of the scenario requirements, users may encounter a subpar experience, characterized by issues like screen lag and reduced frame rates.

To solve this problem, an adaptive multi-window technology is proposed. A platform with the adaptive multi-window technology enables Android™ package (APK) self-adaptive technology (co-worked with eco-system) on multi-window scenario to achieve best user experience of both primary and non-primary windows. Use platform proprietary application programming interfaces (APIs) to allow APKs to provide different profile configurations to the platform through the API, such as FHD@60 fps, FHD@30 fps, 720P@60 fps, etc. The platform determines the profile used based on the power budget and notifies the APK of the chosen profile via the platform API by window priority or other multi-window index. The platform first tries to lower the APK profile of the windows other than the primary window, observing the power change. If the power is low enough, the profile will not be further lowered. If the power budget is not low enough, the profile will continue to be lowered. If the profile has reached the lowest level for the non-primary window and the power budget is still not low enough, the profile of the primary window will be lowered.

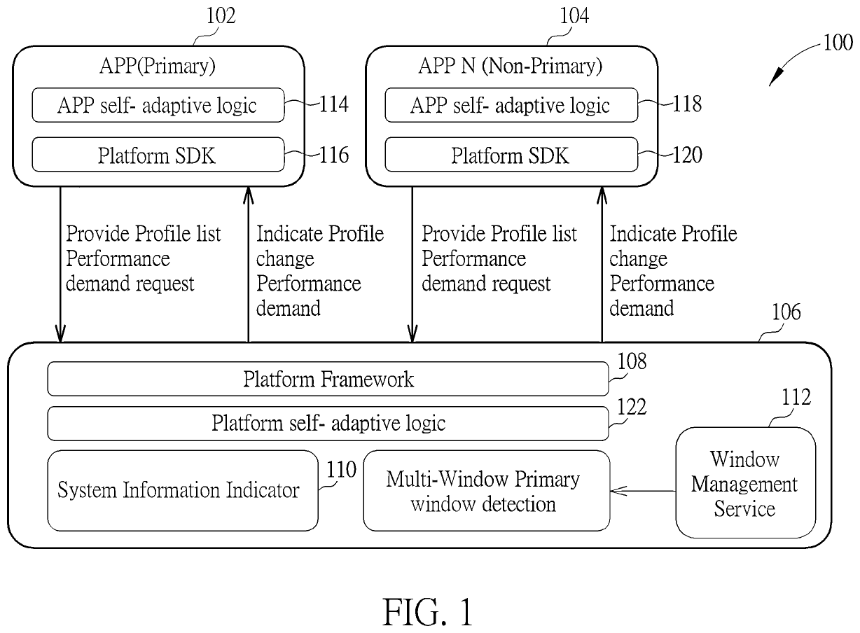

FIG. 1 is a block diagram of an adaptive multi-window technology 100 according to an embodiment of the present invention. The adaptive multi-window technology 100 includes a primary application (APP) 102, a non-primary application (APP) 104, and a platform 106. The primary APP 102 detects the profile of a primary window and provides the profile list to the platform 106 using an APP self-adaptive logic 114 and a platform software development kit (SDK) 116. The profile list may include resolutions and frame rates such as FHD@60 fps, FHD@30 fps and 720P@60 fps. The non-primary APP 104 detects the profile of a non-primary window and provides the profile list to the platform 106 using an APP self-adaptive logic 118 and a platform software development kit (SDK) 120. The profile list may include resolutions and frame rates such as QHD@60 fps, FHD@30 fps and 720P@60 fps. The number of APPs is not limited to 2, and there may be N APPs with one primary window and N−1 non-primary windows, where N is a positive integer.

The platform 106 includes a platform framework 108, a system information indicator 110 and a window management service 112. The window management service 112 is used to detect the priorities of the windows according to the window focus, finger touching, usage time and/or window size. The primary window and the non-primary windows can then be determined by the window management service 112. The system information indicator 110 monitors the performance indexes of user experience according to frames per second (FPS), hardware loading and/or thermal status. For example, when the temperature of the smartphone is higher than a threshold, the platform will indicate the APPs to lower the profile of the APPs according to the priorities and profile lists of the APPs. The system information indicator 110 is used to determine whether to change the profiles of the APPs or not according to the performance indexes.

The platform framework 108 applies a platform self-adaptive logic 122 to lower the profiles of non-primary APPs 104 first and to lower the profile of primary APP 102 at last. The profiles change according to the indications from the platform framework 108 based on a resource re-allocation algorithm. The resource re-allocation algorithm includes lowering profiles of windows other than a primary window until the performance indexes meet predetermined criteria, and if the profiles of the windows other than primary window reach basic criteria, the profiles of the primary window are lowered. The resource re-allocation algorithm is to detect the primary window by the window management service 112, to adjust the corresponding APP profile (e.g. FHD@60 fps to 720P@60 fps) through Platform API to reduce the system resource demand of non-primary windows, and release system resources to the primary window to improve the user experience. If non-primary windows reach minimum profile settings and still cannot satisfy the performance demands, the primary window will continue to lower the resource demand by changing the APK profiles to try to provide better user experience.

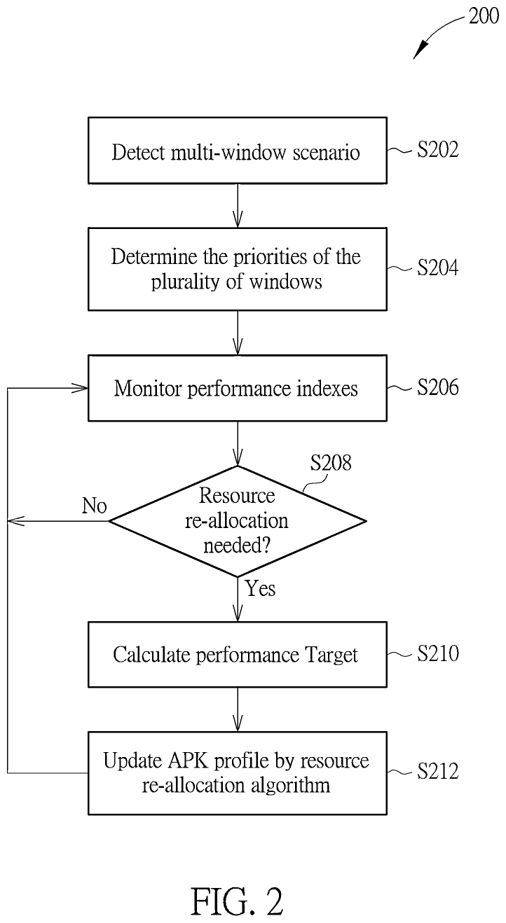

FIG. 2 is a flowchart of a method 200 for adaptive multi-window technology 100 according to an embodiment of the present invention. The method includes the following steps:
Step S202: detect a multi-window scenario;
Step S204: determine priorities of the plurality of windows;
Step S206: monitor performance indexes;
Step S208: check if resource re-allocation is needed; if so, go to step S210; else, go to step S206;
Step S210: calculate performance target;
Step S212: update APK profiles according to the resource re-allocation algorithm; go to step S206.

In step S202, the window management service 112 in the platform 106 detects a multi-window scenario when more than one window is displayed on the smartphone simultaneously. When there is a multi-window scenario, the priorities of the windows are determined by the window management service 112 according to visible window size, sound level, window focus, finger touching, usage time and/or window size. The priorities of the windows can be predicted by an artificial intelligence (AI) model by inputting user behaviors.

In step S206, the system information indicator 110 monitors the system performance indexes such as power, performance, frames per second (FPS), hardware loading and/or thermal status. These performance indexes then determine whether resource re-allocation is needed or not in step S208. If the resource re-allocation is needed, then go to step S210; else, go to step S206 to continue monitoring the performance indexes of the smartphone. In step S210, the performance target is calculated by the platform framework 108. The performance target to lower profiles is determined according to the priorities of the plurality of windows.

In step S212, the APK profiles are updated according to the resource re-allocation algorithm. The platform 106 first tries to lower the APK profiles of the non-primary APP 104, then observe the changes of the performance indexes. When the performance indexes are low enough, the profiles of APPs will not be further lowered. If the performance indexes are not low enough, the profiles of non-primary APPs 104 will continue to be lowered. If the profiles have reached the lowest level for the non-primary windows and the performance indexes are still not low enough, the profiles of the primary APP 102 will be lowered. Thus the resource re-allocation algorithm lowers the profiles of APPs according to the priorities of the APPs.

In conclusion, the method for adaptive multi-window technology includes detecting a multi-window scenario corresponding to a plurality of windows on an electronic device, determining priorities of the plurality of windows, monitoring a plurality of performance indexes of the electronic device, checking whether resource re-allocation is needed according to the performance indexes, determining targets of the plurality of windows if resource re-allocation is needed, and changing profiles of the targets according to a resource re-allocation algorithm. The method updates the profiles of primary and non-primary APPs according to the priorities of the APPs, thus providing a better user experience in a multi-window scenario.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adaptive multi-window technology, comprising:
detecting a multi-window scenario corresponding to a plurality of windows on an electronic device;
determining priorities of the plurality of windows;
monitoring a plurality of performance indexes of the electronic device;
checking whether resource re-allocation is needed according to the performance indexes;
determining targets of the plurality of windows if resource re-allocation is needed; and
changing profiles of the targets according to a resource re-allocation algorithm.

2. The method of claim 1, wherein detecting the priorities of the plurality of windows is detecting the priorities of the plurality of windows according to window focus, finger touching, usage time and/or window size.

3. The method of claim 1, wherein monitoring the plurality of performance indexes is monitoring frames per second (FPS), hardware loading and/or thermal status.

4. The method of claim 1, further comprising the plurality of windows providing profiles to a platform of the electronic device.

5. The method of claim 4, further comprising the platform indicating profile updates to the plurality of windows.

6. The method of claim 4, wherein determining the priorities of the plurality of windows is a window management service of the platform determining the priorities of the plurality of windows.

7. The method of claim 1, wherein checking whether resource re-allocation is needed according to the performance indexes is checking whether resource re-allocation is needed according to frames per second (FPS), hardware loading and/or thermal status.

8. The method of claim 1, wherein the profiles include resolution and frame rate.

9. The method of claim 1, wherein changing the profiles of the targets according to the resource re-allocation algorithm comprises lowering profiles of windows other than a primary window until the performance indexes meet predetermined criteria.

10. The method of claim 9, wherein changing the profiles of the targets according to the resource re-allocation algorithm further comprises if the profiles of the windows other than primary window reach basic criteria, lowering profiles of the primary window.
